(19) United States
(12) Patent Application Publication
(10) Pub. No.: US 2013/0214735 A1
(43) Pub. Date: Aug. 22, 2013

(54) WIRELESS CHARGING APPARATUS AND METHOD

(71) Applicant: Samsung Electronics Co., Ltd., (US)

(72) Inventors: Noh-Gyoung KANG, Seoul (KR); Tae-Han Bae, Seoul (KR); Jae-Seung Son, Gyeonggi-do (KR); Eun-Tae Won, Seoul (KR); Hee-Won Jung, Gyeonggi-do (KR)

(73) Assignee: Samsung Electronics Co., Ltd., Gyeonggi-do (KR)

(21) Appl. No.: 13/772,867

(22) Filed: Feb. 21, 2013

(30) Foreign Application Priority Data
Feb. 21, 2012 (KR) 10-2012-0017476

(51) Int. Cl. H02J 7/02; H02J 17/00

(52) U.S. Cl. CPC H02J 7/025; H02J 17/00
USPC 320/108; 307/104; 320/137; 320/138

(57) ABSTRACT

A wireless charging apparatus and method are provided. The method includes transmitting a power supplying device search signal by a wireless power receiving device; recognizing a plurality of power supplying devices by receiving power supplying device search response signals; sending a power supply request to a first power supplying device among the plurality of power supplying devices; sending a power supply request to a second power supplying device upon receiving a charging rejection signal from the first power supplying device; and performing wireless charging by receiving power from the second power supplying device upon receiving a charging permission signal from the second power supplying device.

### PRIORITY

This application claims priority under 35 U.S.C. §119(a) to a Korean Patent Application filed in the Korean Intellectual Property Office on Feb. 21, 2012 and assigned Serial No. 10-2012-0017476, the entire disclosure of which is incorporated by herein reference.

### BACKGROUND OF THE INVENTION

1. Field of the Invention

The present invention relates generally to a wireless charging apparatus and method, and more particularly, to a wireless charging apparatus and method that uses a wireless power receiving device that wirelessly receives power and wireless power supplying devices for wirelessly supplying power.

2. Description of the Related Art

With the development of Information Telecommunication technologies and the increasing release and prevalence of a variety of portable electronic products, a number of technologies have been developed to supply power to the portable electronic products. While receiving power using a power line was commonly used in the past, many wireless power transmission technologies have been recently developed to make it possible to wirelessly receive power.

Wireless power transmission technology is capable of wirelessly supplying power or electrical energy anytime and anywhere without power lines such as electric wires. Wireless power transmission technology for wirelessly charging electronic devices, supplying wireless power to or wirelessly charging electric vehicles, remotely supplying wireless power, and supplying power to ubiquitous wireless sensors, has attracted attention as a new technology capable of replacing the existing wire charging technology for supplying power via electric wires.

For example, wireless charging technologies may be generally classified into an electromagnetic induction method that uses coils, a resonance method that uses resonance, and a Radio Frequency (RF)/micro wave radiation method that delivers electrical energy by converting it into micro waves. Up to now, electromagnetic induction-based wireless charging technology has been mainly used.

Electromagnetic induction-based wireless charging technology provides power transmission between a primary coil and a secondary coil. Based on the principle that if a magnet is moved against a coil, an induced current is generated, a transmitter (for example, a wireless power supplying device) generates magnetic fields and then a current is induced depending on the change in magnetic field at a receiver (for example, a wireless power receiving device), producing electrical energy. The wireless power receiving device charges its rechargeable battery with the produced electrical energy, thereby performing wireless charging.

Although this wireless charging technology has been commonly used for electric razors and electric boothbrushes, electromagnetic induction-based wireless charging technology has recently been introduced to charge devices such as portable phones and Televisions (TVs), due to the development of an advanced resonance method. However, in the above-described conventional wireless charging technology, a wireless power receiving device is set to receive power only from a first wireless power supplying device which is closest thereto, even though there is a plurality of nearby wireless power supplying devices. Therefore, if the first wireless power supplying device cannot supply power, the wireless power receiving device will not receive power even from other wireless power supplying devices, causing inefficiencies.

### SUMMARY OF THE INVENTION

The present invention has been made to address at least the above-mentioned problems and/or disadvantages and to provide at least the advantages described below. Accordingly, an aspect of the present invention provides a wireless charging apparatus and method, in which when there is a plurality of wireless power supplying devices around a wireless power receiving device, the wireless power receiving device is allowed to perform wireless charging by receiving power from a second wireless power supplying device if an amount of charging power required by the wireless power receiving device is greater than an amount of supply power available from a first wireless power supplying device which is located closest to the wireless power receiving device.

In accordance with one aspect of the present invention, there is provided a wireless charging method, which includes transmitting a power supplying device search signal by a wireless power receiving device; recognizing a plurality of power supplying devices by receiving power supplying device search response signals; sending a power supply request to a first power supplying device among the plurality of power supplying devices; sending a power supply request to a second power supplying device upon receiving a charging rejection signal from the first power supplying device; and performing wireless charging by receiving power from the second power supplying device upon receiving a charging permission signal from the second power supplying device.

In accordance with another aspect of the present invention, there is provided a wireless power receiving device, which includes a communication unit for communicating with a plurality of power supplying devices; a power receiving unit for wirelessly receiving power from any one of the plurality of power supplying devices by frequency resonance that is performed using a resonant coil; and a controller for controlling the communication unit to transmit a power supplying device search signal, recognizing the plurality of power supplying devices upon receiving power supplying device search response signals from the plurality of power supplying devices through the communication unit, controlling the communication unit to send a power supply request signal to a first power supplying device among the plurality of power supplying devices, controlling the communication unit to send a power supply request signal to a second power supplying device upon receiving a charging rejection signal from the first power supplying device through the communication unit, and controlling the power receiving unit to receive power from the second power supplying device upon receiving a charging permission signal from the second power supplying device.

In accordance with a further aspect of the present invention, there is provided a wireless charging method, which includes transmitting, by a wireless power supplying device, a power supplying device search response signal to a wireless power receiving device upon receiving a power supplying device search signal; receiving a power supply request signal from the wireless power receiving device; determining whether an amount of supply power available by the wireless power supplying device is greater than or equal to an amount of supply power requested by the wireless power receiving device; and transmitting a charging rejection signal if the amount of supply power available by the wireless power supplying device is less than the amount of supply power requested by the wireless power receiving device.

In accordance with yet another aspect of the present invention, there is provided a wireless power supplying device, which includes a communication unit for performing communication with a wireless power receiving device; a power supplying unit for transmitting supply power by resonating at a same frequency as a resonant frequency of the wireless power receiving device using a resonant coil; and a power supply controller for receiving a power supplying device search signal from the wireless power receiving device through the communication unit, controlling the communication unit to transmit a power supplying device search response signal to the wireless power receiving device, determining whether an amount of supply power available by the wireless power supplying device is greater than or equal to an amount of supply power requested by the wireless power receiving device, upon receiving a power supply request signal from the wireless power receiving device, and transmitting a charging rejection signal through the communication unit if the amount of available supply power is less than the amount of supply power requested by the wireless power receiving device.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 illustrates a block diagram of a wireless charging apparatus according to an embodiment of the present invention;

FIG. 2 is a flow diagram illustrating a wireless charging method between a wireless power receiving device and wireless power supplying devices according to an embodiment of the present invention;

FIG. 3 is a flowchart illustrating an operation of a mobile terminal according to an embodiment of the present invention; and

FIG. 4 is a flowchart illustrating an operation of a wireless power supplying device according to an embodiment of the present invention.

Throughout the drawings, the same drawing reference numerals will be understood to refer to the same elements, features and structures.

### DETAILED DESCRIPTION OF EMBODIMENTS OF THE PRESENT INVENTION

Embodiments of the present invention will now be described in detail with reference to the accompanying drawings. In the following description, specific details such as detailed configurations and components are merely provided to assist the overall understanding of the embodiments of the present invention. Therefore, it should be apparent to those skilled in the art that various changes and modifications of the embodiments described herein can be made without departing from the scope and spirit of the invention. In addition, descriptions of well-known functions and constructions may be omitted for clarity and conciseness.

According to the present invention, a wireless charging apparatus includes a wireless power receiving device and a plurality of wireless power supplying devices. This wireless charging apparatus of the present invention may be applied to wirelessly charging portable electronic devices, supplying wireless power to or wirelessly charging electric vehicles, remotely supplying wireless power, and supplying power to ubiquitous wireless sensors, and may also be applied to any devices as long as they supply and receive wireless power. In this description, a device supplying wireless power will be referred to as a wireless power supplying device, and a device receiving wireless power will be referred to as a wireless power receiving device. The configuration and operation of the present invention will be described on the assumption that the wireless power supplying device and the wireless power receiving device correspond to a charging pad and a mobile terminal, respectively.

In accordance with embodiments of the present invention, if there is a plurality of charging pads (or wireless power supplying devices) around a mobile terminal (or a wireless power receiving device), the mobile terminal recognizes the plurality of charging pads. The mobile terminal determines whether there is a charging pad capable of supplying power among the plurality of charging pads, in order of the charging pad from which the mobile terminal is most likely to receive power, depending on their distance and Received Signal Strength Indication (RSSI), and receives power from the determined charging pad if it can supply power.

For example, if there is a plurality of charging pads around a mobile terminal, the mobile terminal determines whether it can receive power from a first charging pad which is closest thereto, and may receive power from a second charging pad which is the next closest thereto after the first charging pad, if the mobile terminal cannot receive power from the first charging pad. If the mobile terminal still cannot receive power from the second charging pad, the mobile terminal may receive power from a third charging pad which is the next closest thereto after the second charging pad. The mobile terminal determines whether it can receive power from each charging pad, by receiving a charging permission signal and a charging rejection signal from each charging pad.

Upon a power supply request from the mobile terminal, each of the plurality of charging pads compares its available charging capacity (an amount of its available charging power) with an amount of charging power required by the mobile terminal. If its available charging capacity is greater than or equal to the required amount of charging power, the charging pad transmits a charging permission signal to the mobile terminal. If its available charging capacity is less than the required amount of charging power, the charging pad transmits a charging rejection signal to the mobile terminal. As a result, the mobile terminal of the present invention receives power from a charging pad capable of charging, among the plurality of nearby charging pads, even if it cannot receive power from the closest charging pad.

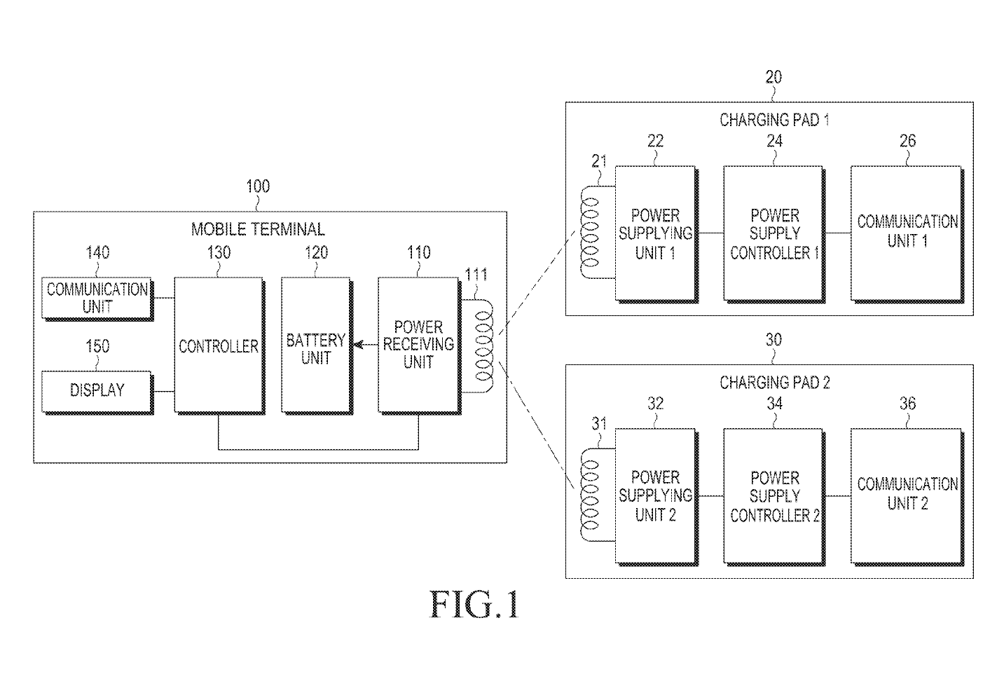

FIG. 1 illustrates a block diagram of a wireless charging apparatus according to an embodiment of the present invention. Referring to FIG. 1, the wireless charging apparatus according to an embodiment of the present invention includes a mobile terminal 100, and a plurality of charging pads, such as a first charging pad 20 and a second charging pad 30. In the present invention, it will be assumed that there are two charging pads, e.g., the first and second charging pads 20 and 30, around the mobile terminal 100, and the charging pad closest to the mobile terminal 100 is the first charging pad 20. Although the number of charging pads is assumed to be two in this embodiment of the present invention, the number of charging pads may be three or more.

In accordance with an embodiment of the present invention, the mobile terminal 100 includes a power receiving unit 110, a battery unit 120, a controller 130, a communication unit 140, and a display 150.

The power receiving unit 110 receives supply power through a resonant coil 111 as a power supplying unit (e.g., one of first and second power supplying units 22 and 32) in one of the charging pads 20 and 30 resonates at the same frequency as that of a resonant coil (e.g., one of first and second resonant coils 21 and 31), and the power receiving unit 110 supplies the received power to the battery unit 120. The battery unit 120 charges a rechargeable battery using the power received by the power receiving unit 110, and when the charging is completed, the battery unit 120 notifies the controller 130.

The controller 130 controls the overall operation of receiving power from any one of the plurality of charging pads. The controller 130 determines whether it needs to receive power (or needs to charge a battery) by checking a remaining power level of the battery unit 120. If it needs to receive power, the controller 130 transmits a power supplying device search signal through the communication unit 140, and recognizes its nearby charging pads (e.g., the first and second charging pads 20 and 30) by receiving a power supplying device search response signal(s) through the communication unit 140. The controller 130 sends, through the communication unit 140, a power supply request to the first charging pad 20, which is a charging pad from which the mobile terminal 100 is most likely to receive power, among its nearby first and second charging pads 20 and 30. The charging pad from which the mobile terminal 100 is most likely to receive power refers to a charging pad which is most likely to supply power to the mobile terminal 100. The charging pad which is most likely to supply power to the mobile terminal 100 may be a charging pad which is closest to the mobile terminal 100, or whose RSSI is highest. The controller 130 sends, through the communication unit 140, a power supply request to the first charging pad 20, which is a charging pad closest to the mobile terminal 100, or whose RSSI is highest, from which the mobile terminal 100 is most likely to receive power, among nearby first and second charging pads 20 and 30.

Upon receiving a charging permission signal from the first charging pad 20 through the communication unit 140, the controller 130 controls the power receiving unit 110 to receive power from the first charging pad 20. On the other hand, upon receiving a charging rejection signal from the first charging pad 20 through the communication unit 140, the controller 130 sends a power supply request to the second charging pad 30, and controls the power receiving unit 110 to receive power from the second charging pad 30 in response to a charging permission signal from the second charging pad 30, thereby performing charging.

The communication unit 140, under control of the controller 130, performs communication with each of the first and second charging pads 20 and 30 to deliver a signal received from each of the first and second charging pads 20 and 30 to the controller 130. The communication unit 140 transmits a transmission signal requested by the controller 130, to each of the first and second charging pads 20 and 30. The communication unit 140 may be comprised of a short-range wireless communication module, for example, a Near Field Communication (NFC) Integrated Circuit (IC), and may perform communication with each of the first and second charging pads 20 and 30 over an NFC channel.

The display 150 may be a Liquid Crystal Display (LCD) display device or an

Organic Light Emitting Diode (OLED) display device, and under control of the controller 130, the display 150 displays the battery level, or displays whether the battery needs to be charged. Also, the display 150, under control of the controller 130, displays the presence of the nearby first and second charging pads 20 and 30, and displays a charging permission signal or a charging rejection signal from the first and second charging pads 20 and 30.

Each of the first and second charging pads 20 and 30 are a power supplying device capable of wirelessly supplying power to the mobile terminal 100, and have the same components for supplying wireless power. The first and second charging pads 20 and 30 are different only in terms of their adjacency to the mobile terminal 100. In FIG. 1, it is assumed that the first charging pad 20 is located closer to the mobile terminal 100, compared with the second charging pad 30.

In the present invention, since the first and second charging pads 20 and 30 have the same components, a description of the components of the second charging pad 30 will be omitted. The first power supplying unit 22 corresponds to the second power supplying unit 32, a first power supply controller 24 corresponds to a second power supply controller 34, and a first communication unit 26 corresponds to a second communication unit 36.

A configuration of the first charging pad 20 will now be described, and includes the first power supplying unit 22, the first power supply controller 24, and the first communication unit 26.

The first power supplying unit 22 transmits supply power through the first resonant coil 21, by resonating at the same frequency as that of the resonant coil 111 of the power receiving unit 110 in the mobile terminal 100.

The first power supply controller 24 controls the overall operation of supplying power by the first charging pad 20. Upon receiving a power supplying device search signal from the mobile terminal 100 through the first communication unit 26, the first power supply controller 24 sends a power supplying device search response signal in response thereto. In addition, upon receiving a power supply request signal from the mobile terminal 100 through the first communication unit 26, the first power supply controller 24 compares its available charging capacity (or its available supply power capacity) with an amount of charging power required (or power capacity required) by the mobile terminal 100. Depending on whether the available charging capacity is greater than or equal to the required amount of charging power, the first power supply controller 24 transmits a charging permission signal or a charging rejection signal to the mobile terminal 100 via the first communication unit 26. When it has transmitted the charging permission signal to the mobile terminal 100, the first power supply controller 24 determines a resonant frequency at which it can exchange wireless power with the mobile terminal 100, transmits the determined resonant frequency to the mobile terminal 100, and controls the first power supplying unit 22 to supply power to the mobile terminal 100 depending on the determined resonant frequency. To determine the resonant frequency, the first power supply controller 24 recognizes a resonant frequency of the nearby second charging pad 30 that exists within a predetermined distance from the first charging pad 20, and the first power supply controller 24 may determine a resonant frequency which is different from the resonant frequency used by the nearby second charging pad 30, as a resonant frequency for supplying power to the mobile terminal 100.

The first communication unit 26, under control of the first power supply controller 24, performs communication with the communication 140 of the mobile terminal 100, and delivers a signal received from the mobile terminal 100 to the first power supplying unit 22. The first communication unit 26 transmits a transmission signal requested by the first power supply controller 24, to the mobile terminal 100. The first communication unit 26 may be comprised of a short-range wireless communication module, for example, an NFC IC, and may perform communication with the mobile terminal 100 over an NFC channel.

A process of charging a battery by receiving power from one of the nearby first and second charging pads 20 and 30 by the mobile terminal 100 according to an embodiment of the present invention will be described in detail below.

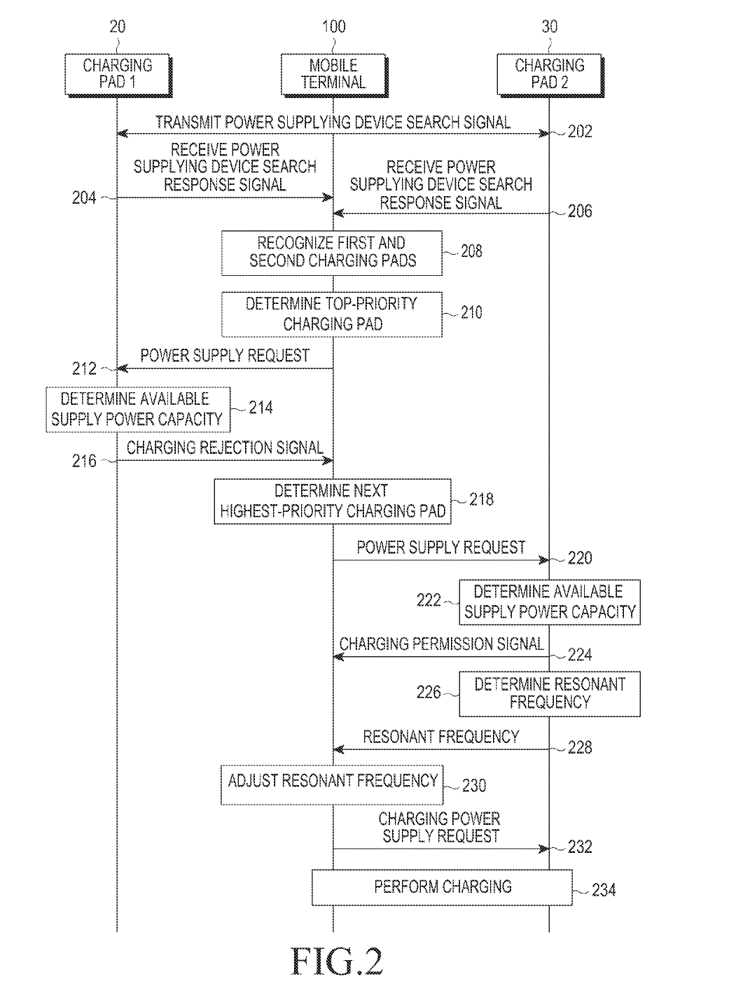

FIG. 2 is a flow diagram illustrating a wireless charging method between a wireless power receiving device and wireless power supplying devices according to an embodiment of the present invention. In the process of FIG. 2, the mobile terminal 100 charges its rechargeable battery by receiving power from the nearby first and second charging pads 20 and 30. Referring to FIG. 2, the mobile terminal 100 transmits a power supplying device search signal in step 202, in order to receive power from any one of a plurality of nearby charging pads.

The first and second charging pads 20 and 30 existing around the mobile terminal 100 receive the power supplying device search signal and transmit a power supplying device search response signal in response thereto, in steps 204 and 206, respectively.

Upon receiving the power supplying device search response signal transmitted from each of the first and second charging pads 20 and 30, the mobile terminal 100 recognizes the nearby first and second charging pads 20 and 30 in step 208.

In step 210, the mobile terminal 100 determines a top-priority charging pad (which is closest to the mobile terminal 100 or whose RSSI is highest) from which the mobile terminal 100 is most likely to receive power (or to charge a battery) among the first and second charging pads 20 and 30. In the embodiment shown in FIG. 2, the first charging pad 20 is assumed to be a charging pad which is closest to the mobile terminal 100. Thus, in step 212, the mobile terminal 100 sends a power supply request to the first charging pad 20, which is the closest charging pad.

In step 214, the first charging pad 20 determines its available supply power capacity (or its available charging capacity). Specifically, the first charging pad 20 compares its available supply power capacity with an amount of charging power required (or the supply power capacity required) by the mobile terminal 100, and transmits a charging permission signal or a charging rejection signal to the mobile terminal 100 depending on whether the available supply power capacity is greater than or equal to the required amount of charging power. In FIG. 2, the available supply power capacity of the first charging pad 20 is assumed to be less than the amount of charging power required by the mobile terminal 100. Thus, in step 216, the first charging pad 20 transmits a charging rejection signal to the mobile terminal 100.

Upon receiving the charging rejection signal from the first charging pad 20, the mobile terminal 100 determines, in step 218, a charging pad from which the mobile terminal 100 is next most likely to receive power after the first charging pad 20. In FIG. 2, the second charging pad 30, which is next closest to the mobile terminal 100 after the first charging pad 20, is assumed to be the charging pad from which the mobile terminal 100 is next most likely to receive power after the first charging pad 20. Accordingly, in step 220, the mobile terminal 100 sends a power supply request to the second charging pad 30.

In step 222, the second charging pad 30 determines its available supply power capacity (or its available charging capacity). Specifically, the second charging pad 30 compares its available supply power capacity with an amount of charging power required (or the supply power capacity required) by the mobile terminal 100, and transmits a charging permission signal or a charging rejection signal to the mobile terminal 100 depending on whether the available supply power capacity is greater than or equal to the required amount of charging power. In the embodiment shown in FIG. 2, the available supply power capacity of the second charging pad 30 is assumed to be greater than or equal to the amount of charging power required by the mobile terminal 100. Accordingly, in step 224, the second charging pad 30 transmits a charging permission signal to the mobile terminal 100.

In step 226, the second charging pad 30 determines a resonant frequency at which it can exchange wireless power with the mobile terminal 100. To determine the resonant frequency, the second charging pad 30 recognizes a resonant frequency of other power supplying devices that exist within a predetermined distance from the second charging pad 30, and the second charging pad 30 determines a resonant frequency which is different from the resonant frequency used by nearby charging pads, as a resonant frequency for supplying power to the mobile terminal 100. After determining the resonant frequency, the second charging pad 30 transmits the determined resonant frequency to the mobile terminal 100 in step 228. In an alternative embodiment of the present invention, a predetermined resonant frequency may be used without determining the resonant frequency.

Upon receiving the resonant frequency from the second charging pad 30, the mobile terminal 100 adjusts its own resonant frequency to the received resonant frequency in step 230. Thereafter, the mobile terminal 100 sends a charging power supply request to the second charging pad 30 in step 232, and the mobile terminal 100 and the second charging pad 30 perform wireless charging by exchanging wireless power in step 234.

As a result, in the wireless charging apparatus of the present invention, the mobile terminal 100 receives power from the second charging pad 30, which is another nearby charging pad capable of charging, even though the mobile terminal 100 is unable to receive power from the first charging pad 20 which is closest thereto.

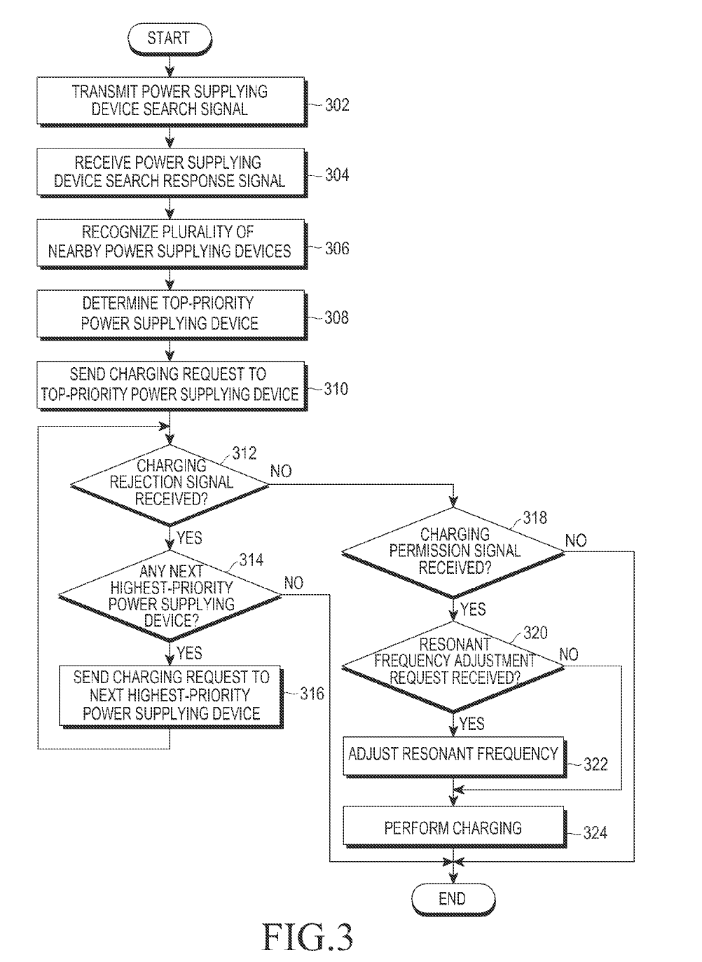

FIG. 3 is a flowchart illustrating the operation of a mobile terminal 100 to receive power from another charging pad capable of charging, even though it is unable to receive power from the closest charging pad among nearby charging pads, according to an embodiment of the present invention. In FIG. 3, it is assumed that there exists only two power supplying devices, i.e. first and second charging pads 20 and 30. Referring to FIG. 3, in step 302, the mobile terminal 100 transmits a power supplying device search signal through the communication unit 140 if it needs to receive power (or to charge its battery).

The mobile terminal 100 receives a power supplying device search response signal through the communication unit 140 in step 304, and recognizes a plurality of nearby power supplying devices depending on the received power supplying device search response signal(s) in step 306.

In step 308, the mobile terminal 100 determines a top-priority power supplying device from which the mobile terminal 100 is most likely to receive power, among the plurality of its nearby power supplying devices. For example, the mobile terminal 100 determines a power supplying device, which is closest to the mobile terminal 100, or whose RSSI is highest.

In step 310, the mobile terminal 100 sends a charging request to the top-priority power supplying device. Specifically, the mobile terminal 100 sends a power supply request to the top-priority power supplying device. In step 312, the mobile terminal 100 determines if a charging rejection signal is received from the top-priority power supplying device.

If a charging rejection signal is not received by the mobile terminal 100, the mobile terminal 100 determines in step 318 whether a charging permission signal is received from the top-priority power supplying device. If a charging permission signal is not received, and there exists only two power supplying devices (i.e. charging pads 20 and 30), the process ends. Upon receiving the charging permission signal, the mobile terminal 100 determines in step 320 whether a resonant frequency adjustment request signal is received from the top-priority power supplying device. Upon receiving the resonant frequency adjustment request signal, the mobile terminal 100 adjusts the resonant frequency in step 322, and performs wireless charging with the top-priority power supplying device in step 324. On the other hand, if a resonant frequency adjustment request signal is not received, the mobile terminal 100 performs wireless charging in step 324, without adjusting the resonant frequency.

Referring back to step 312, upon receiving a charging rejection signal in step 312, the mobile terminal 100 determines in step 314 whether there is a next highest-priority power supplying device. If there is a next highest-priority power supplying device, the mobile terminal 100 sends a charging request to the next highest-priority power supplying device in step 316, and then returns to step 312. However, if there is no next highest-priority power supplying device, the mobile terminal 100 ends the operation, recognizing that it cannot wirelessly charge its battery.

According to the above-described operation, the mobile terminal 100 repeats steps 312 to 316 until a charging permission signal is received from the plurality of power supplying devices, and performs steps 318 to 324 upon receiving the charging permission signal. As a result, the mobile terminal 100 performs wireless charging by receiving power from a power supplying device from which it is next most likely to receive power, even though the mobile terminal 100 cannot charge its battery by receiving power from the top-priority power supplying device among the plurality of power supplying devices.

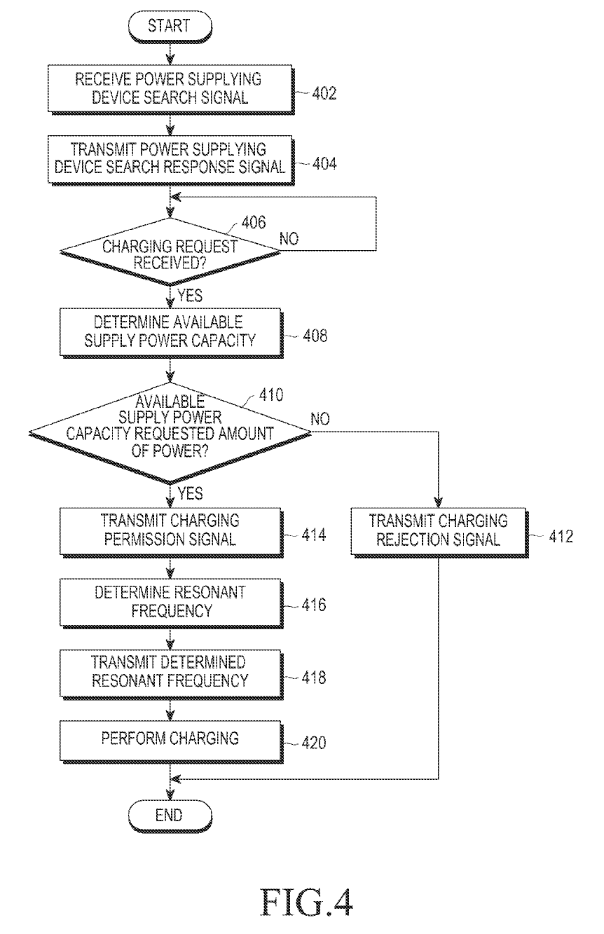

FIG. 4 is a flowchart illustrating an operation of a wireless power supplying device according to an embodiment of the present invention. In the embodiment shown in FIG. 4, the power supplying device is assumed to be a first charging pad 20. However, the operation of the first charging pad 20 is the same as that of the second charging pad 30, and may be applied to a plurality of other power supplying devices.

Referring to FIG. 4, upon receiving a power supplying device search signal from the mobile terminal 100 in step 402, the first charging pad 20 transmits a power supplying device search response signal in step 404.

In step 406, the first charging pad 20 determines whether a charging request signal (or a power supply request signal) is received from the mobile terminal 100. Upon receiving a power supply request signal, the first charging pad 20 determines its available charging capacity (or the power supply capacity) it can supply to the mobile terminal 100, in step 408. In step 410, the first charging pad 20 determines if its available charging capacity is greater than or equal to an amount of charging power (or the supply power capacity) required by the mobile terminal 100.

If its available charging capacity is greater than or equal to the amount of charging power required by the mobile terminal 100, the first charging pad 20 transmits a charging permission signal to the mobile terminal 100 in step 414. In step 416, the first charging pad 20 determines a resonant frequency at which it can exchange wireless power with the mobile terminal 100. To determine the resonant frequency, the first charging pad 20 recognizes a resonant frequency of other nearby power supplying devices which are located within a predetermined distance from the first charging pad 20, and the first charging pad 20 determines a resonant frequency which is different from the resonant frequency used by the nearby charging pads, as a resonant frequency for supplying power to the mobile terminal 100.

The first charging pad 20 transmits the determined resonant frequency to the mobile terminal 100 in step 418, and performs wireless charging by exchanging wireless power with the mobile terminal 100 in step 420.

If it is determined in step 410 that its available supply power capacity is less than the required amount of charging power, the first charging pad 20 transmits a charging rejection signal to the mobile terminal 100 in step 412. In response, the mobile terminal 100 may send a charging request to another power supplying device, recognizing that the first charging pad 20 cannot charge the battery of the mobile terminal 100.

In accordance with the above-described wireless charging method and apparatus of the present invention, when there is a plurality of wireless power supplying devices around a wireless power receiving device, the wireless power receiving device can receive power from another wireless power supplying device even if the closest wireless power supplying device cannot supply power, making it possible to efficiently receive power. In addition, even if an amount of supply power available by a wireless power supplying device which is closest to a wireless power receiving device is less than an amount of charging power required by the wireless power receiving device, the wireless power receiving device can receive power from another nearby wireless power supplying device, so the user does not need to move the wireless power receiving device to a position where it is closest to another wireless power supplying device, to charge the wireless power receiving device.

Although the wireless power receiving device described herein is assumed to be a mobile terminal and the wireless power supplying device is assumed to be a charging pad in the embodiments of the present invention, the wireless power receiving device may include any device that wirelessly receives power, and the wireless power supplying device may include any device that wirelessly supplies power.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A wireless charging method comprising:
transmitting, by a wireless power receiving device, a power supplying device search signal;
recognizing a plurality of power supplying devices by receiving power supplying device search response signals;
sending, by the wireless power receiving device, a power supply request to a first power supplying device among the plurality of power supplying devices;
sending, by the wireless power receiving device, a power supply request to a second power supplying device upon receiving a charging rejection signal from the first power supplying device; and
performing wireless charging by receiving power from the second power supplying device upon receiving, by the wireless power receiving device, a charging permission signal from the second power supplying device.

2. The wireless charging method of claim 1, wherein the first power supplying device is a power supplying device from which the wireless power receiving device is most likely to receive power, among the plurality of power supplying devices.

3. The wireless charging method of claim 2, wherein the power supplying device from which the wireless power receiving device is most likely to receive power is a power supplying device which is closest to the wireless power receiving device.

4. The wireless charging method of claim 2, wherein the power supplying device from which the wireless power receiving device is most likely to receive power is a power supplying device which has a highest Received Signal Strength Indication (RSSI), among the plurality of power supplying devices.

5. A wireless power receiving device comprising:
a communication unit for communicating with a plurality of power supplying devices;
a power receiving unit for wirelessly receiving power from any one of the plurality of power supplying devices by frequency resonance that is performed using a resonant coil; and
a controller for controlling the communication unit to transmit a power supplying device search signal, recognizing the plurality of power supplying devices upon receiving power supplying device search response signals from the plurality of power supplying devices through the communication unit, controlling the communication unit to send a power supply request signal to a first power supplying device among the plurality of power supplying devices, controlling the communication unit to send a power supply request signal to a second power supplying device upon receiving a charging rejection signal from the first power supplying device through the communication unit, and controlling the power receiving unit to receive power from the second power supplying device upon receiving a charging permission signal from the second power supplying device.

6. The wireless power receiving device of claim 5, further comprising a battery unit which is charged with the received power.

7. The wireless power receiving device of claim 5, wherein the first power supplying device is a power supplying device from which the wireless power receiving device is most likely to receive power, among the plurality of power supplying devices.

8. The wireless power receiving device of claim 7, wherein the power supplying device from which the wireless power receiving device is most likely to receive power is a power supplying device which is closest to the wireless power receiving device.

9. The wireless power receiving device of claim 7, wherein the power supplying device from which the wireless power receiving device is most likely to receive power is a power supplying device which has a highest RSSI, among the plurality of power supplying devices.

10. A wireless charging method comprising:
transmitting, by a wireless power supplying device, a power supplying device search response signal to a wireless power receiving device upon receiving a power supplying device search signal;
receiving a power supply request signal from the wireless power receiving device;
determining whether an amount of supply power available by the wireless power supplying device is greater than or equal to an amount of supply power requested by the wireless power receiving device; and
transmitting a charging rejection signal if the amount of supply power available by the wireless power supplying device is less than the amount of supply power requested by the wireless power receiving device.

11. The wireless charging method of claim 10, further comprising:
transmitting a charging permission signal, if the amount of supply power available by the wireless power supplying device is greater than or equal to the amount of supply power requested by the wireless power receiving device; and
transmitting wireless power to the wireless power receiving device.

12. The wireless charging method of claim 11, further comprising determining a resonant frequency for transmitting the wireless power, and transmitting the determined resonant frequency to the wireless power receiving device.

13. The wireless charging method of claim 12, wherein the determining a resonant frequency comprises determining, as a resonant frequency for transmitting the wireless power, a resonant frequency which is different from resonant frequencies of other power supplying devices which are located within a predetermined distance from the wireless power supplying device.

14. A wireless power supplying device comprising:
a communication unit for performing communication with a wireless power receiving device;
a power supplying unit for transmitting supply power by resonating at a same frequency as a resonant frequency of the wireless power receiving device using a resonant coil; and
a power supply controller for receiving a power supplying device search signal from the wireless power receiving device through the communication unit, controlling the communication unit to transmit a power supplying device search response signal to the wireless power receiving device, determining whether an amount of supply power available by the wireless power supplying device is greater than or equal to an amount of supply power requested by the wireless power receiving device, upon receiving a power supply request signal from the wireless power receiving device, and transmitting a charging rejection signal through the communication unit if the amount of available supply power is less than the amount of supply power requested by the wireless power receiving device.

15. The wireless power supplying device of claim 14, wherein the power supply controller controls the communication unit to transmit a charging permission signal if the amount of available supply power is greater than or equal to the amount of supply power requested by the wireless power receiving device, and controls the power supplying unit to supply wireless power to the wireless power receiving device.

16. The wireless power supplying device of claim 14, wherein the power supply controller determines a resonant frequency for transmitting the wireless power, and transmits the determined resonant frequency to the wireless power receiving device.

17. The wireless power supplying device of claim 16, wherein the power supply controller determines, as a resonant frequency for transmitting the wireless power, a resonant frequency which is different from resonant frequencies of other power supplying devices which are located within a predetermined distance from the wireless power supplying device.
